(19) United States
(12) Patent Application Publication
(10) Pub. No.: US 2006/0108021 A1
(43) Pub. Date: May 25, 2006

(54) Filling device for capsules, in particular medicament capsules

(76) Inventors: Bettina Knorr, Munchen (DE); Florian Strohmaier, Oberteisendorf (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/524,041

(22) PCT Filed: Aug. 6, 2003
(86) PCT No.: PCT/EP03/08695

§ 371 Date: Oct. 27, 2005

(30) Foreign Application Priority Data
Aug. 7, 2002 (DE) 102 36 241.6

(51) Int. Cl. B67C 3/00

(52) U.S. Cl. 141/129

(57) ABSTRACT

The invention relates to a filling device for capsules, in particular medicament capsules. Said device comprises: a first transport device (1), which feeds a liquid medium (2) containing the capsules (3) with a defined volumetric flow via a first supply conduit (5, 6) to a collection container (17); a detector device (12), which detects and counts the capsules (3) that pass a measuring point (14) in the first supply conduit (5, 6); a control device, which stops the first transport device (1) when a predetermined number of capsules (3) has been reached and compares the actual volume fed to the collection container (17) with a target volume to be filled, forming a differential volume value; and a second transport device (1′), which feeds the liquid medium (2′) to the collection container (17) via a second supply conduit (5′, 6′) until the target volume has been reached. The invention also relates to a method for filling capsules in a collection container.

The invention relates to a filling device for capsules, in particular medicament capsules, and to a method for filling capsules.

U.S. Pat. No. 5,456,102 discloses a counting apparatus for particles in which particles entrained in a fluid stream are guided through an optical measuring zone and are detected therein by means of a light beam. In this case, particle properties, such as the particle size, can be determined.

EP 0 556 748 B1 discloses an apparatus for handling particles, comprising a conveying device which feeds a liquid medium containing the particles with a defined volume flow to a collecting vessel via a feed line, and comprising a detector device which detects the particles passing a measuring point in the feed line.

EP 0 579 467 A1 discloses a filling device for a solid-liquid mixture, containing a first conveying device, which feeds a liquid medium containing the solids with a defined volume flow to a collecting vessel via a first feed line, and also a second conveying device, which feeds a liquid medium to the collecting vessel via a second feed line.

It is an object of the invention to provide a filling device mentioned at the beginning which, with a simple construction, permits accurate determination of the number of capsules filled and a defined filling of a filling vessel, and also to specify a method for filling capsules that is suitable for this purpose.

According to the invention, this object is achieved by a filling device containing a first conveying device, which feeds a liquid medium containing the capsules with a defined volume flow to a collecting vessel via a first feed line, a detector device, which detects and counts the capsules passing a measuring point in the first feed line, a control device, which stops the first conveying device when a predetermined number of capsules is reached and compares the actual volume fed to the collecting vessel with a desired volume to be filled and forms a volume difference value, and a second conveying device, which feeds liquid medium to the collecting vessel via a second feed line as a function of the determined volume difference value until the desired volume is reached.

The object is further achieved by a method for filling capsules, in particular medicament capsules, into a collecting vessel, a liquid medium containing the capsules being fed with a defined volume flow to a collecting vessel, the capsules passing a measuring point in the first feed line being detected and counted, the feed of the liquid medium containing the capsules being stopped when a predetermined number of capsules is reached, the actual volume fed to the collecting vessel being compared with a desired volume to be put in and a volume difference value being formed and, if required, liquid medium being fed to the collecting vessel as a function of this volume difference value until the desired volume is reached.

By means of the filling device according to the invention, even small capsules with a size of, for example, about 0.4 to 1.3 mm, which can have a viscoelastic capsule body or a viscoelastic capsule sheath, can be put in accurately and without damage. The liquid culture medium for the cells is used as a carrier and transport medium for the capsules. On the transport path of the first conveying device, the capsules are separated at the measuring point and, as a result, can be counted exactly, the detector device also permitting a determination of size. Since, during filling, both the number of capsules put in and the filled volume of capsules and liquid medium are monitored and registered, by means of a second conveying device, in particular the same liquid medium can be put into the collecting container, so that the latter always has a defined desired filling volume of liquid with the specific number of capsules.

Advantageous refinements of the invention are specified in the respective subclaims.

Use is preferably made of two transparent capillaries mounted on a holder in order to lead the liquid medium containing the capsules past the measuring point, being connected by means of flexible hoses to a respective pump, such as a hose or peristaltic pump, and, together with the holder detachably fixed to the filling device and the hoses, being capable of removal from the filling device.

For the purpose of simple operation and rapid mounting and detachment, the holder is preferably mounted on a pivot axis and can be fixed in a latching position by means of a locking device. By being pivoted about the pivot axis, the holder can be released from the latching position and removed from the pivot axis. This action is easy to carry out under clean room conditions, even for an operator wearing gloves.

In the following text, an exemplary embodiment of the filling device will be explained in more detail with reference to the drawing, in which:

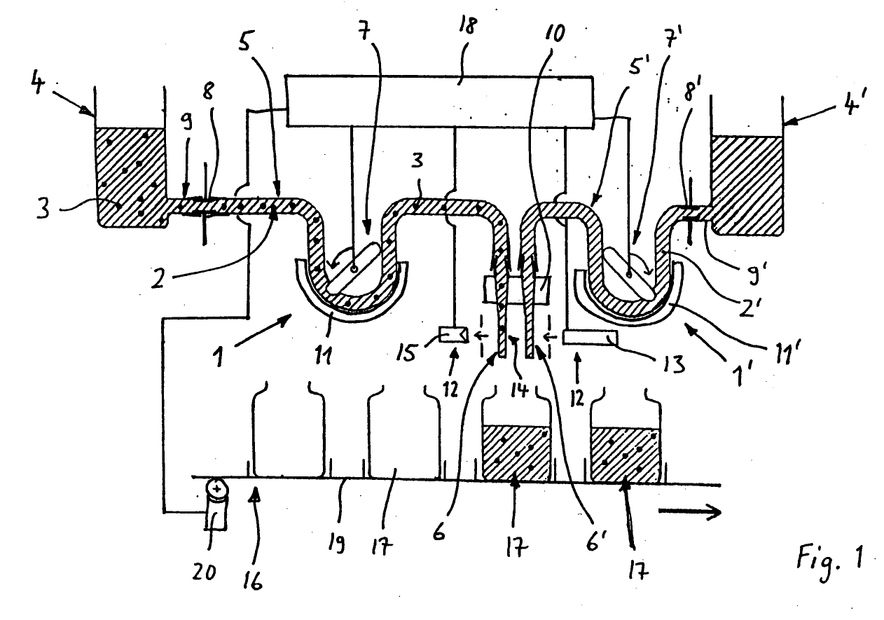

FIG. 1 shows a filling device in a plan view in a schematic illustration; and

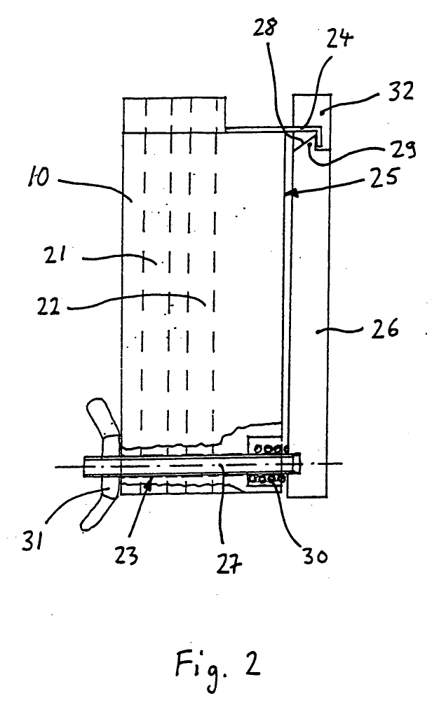

FIG. 2 shows a holder for capillaries of the filling device in a side view.

A filling device for medicament capsules which, for example, have a spherical or droplet shape with a size of, for example, about 0.4 to 1.3 mm, contains a first conveying device 1, which conveys a liquid medium 2 with capsules 3 contained therein from a storage container 4 via a hose line 5 to a capillary 6 by means of a hose pump 7, for example a peristaltic pump. On one side, toward the storage container 4, the hose line 5 is plugged detachably onto a connecting piece 8. The connecting piece 8 is either a section of a discharge line 9 of the storage container 4, which is a constituent part of the filling device, or it is used at the same time as a connection fixed to the housing for an external storage container 4, which is not a constituent part of the filling device.

On the other side, the hose line 5 is plugged onto the capillary 6, which is fitted to a holder 10 which, in turn, is detachably fixed to the filling device by means of a latching or snap-action connection or a screw connection. Furthermore, the hose line 5 is placed on a hose guide 11 which has the shape of a circular arc and is concentric with respect to the hose pump 7 and forms the supporting surface for the hose line 5 in the region of the hose pump 7.

The filling device further contains a second conveying device 1′, which is constructed in a manner corresponding to the first conveying device 1 and conveys a liquid medium 2′, which is expediently the same as the liquid medium 2, from a storage container 4′ via a hose line 5′ to a capillary 6′ by means of a hose pump 7′, for example a peristaltic pump, in a manner corresponding to the first conveying device 1. Here, too, on one side toward the storage container 4′, the hose line 5′ is plugged detachably onto a connecting piece 8′, the connecting piece 8′ either being a section of a discharge line 9′ of the storage container 4′, which is a constituent part of the filling device, or being used at the same time as a connection fixed to the housing for an external storage container 4′, which is not a constituent part of the filling device. The capillary 6′ is likewise fitted to the holder 10 which, for example, is divided into two and the two capillaries 6 and 6′ are clamped firmly between its two halves, or which has two parallel bores, into which the two capillaries 6 and 6′ are inserted. The capillaries 6 and 6′ are, for example, tapering small pipette tubes made of glass with an internal diameter of 5.5 mm at the fitting of the hose line 5 and 5′, and an internal diameter of 1.4 mm at a measuring point of a detector device 12, described below. The hose lines 5, 5′ are hoses made of silicon rubber or PU.

FIG. 2 shows an exemplary embodiment of the holder 10, which has two bores 21 and 22, which are adjacent and vertical when installed, to accommodate the two capillaries 6 and 6′. In its lower section, the holder 10 contains a hole 23 and, in its opposite upper section, a spring hook 24, which projects beyond the rear 25 of the holder 10. A bearing plate 26 for accommodating the holder 10 contains a protruding threaded bolt 27, onto which the vertically aligned holder 10 can be pushed by its hole 23. When the holder 10 is pushed against the bearing plate 26, the spring hook 24 slides on an inclined face 28 of a locking tooth 29 which is assigned to the spring hook 24 and is formed at the upper end of the bearing plate 26, until the elastically deflected spring hook 24 finally latches into its locking position behind the locking tooth 29 in the fixing position of the holder 10 illustrated. The holder 10 is fixed to the bearing plate 26 counter to the spring force of an interposed helical spring 30 arranged on the threaded bolt 27 and can, for example, be secured by means of a wing nut 31 held on the threaded bolt 27. The locking tooth 29 is bounded on one side by an upwardly projecting shoulder 32 of the bearing plate 26. This shoulder 32 prevents the spring hook 24 or the holder 10 pivoting about a pivot axis formed by the threaded bolt 27 in this one pivoting direction (pivoting direction in the plane of the drawing of FIG. 2).

In order to remove the holder 10 with the capillaries and hose lines held thereon from the bearing plate 26, the holder 10 is pivoted about the threaded bolt 27 in the other pivoting direction (that is to say out of the plane of the drawing of FIG. 2 toward the observer, in the lateral direction in FIG. 1, that is to say to the right or to the left, depending on the design), so that the spring hook 24 is displaced beside the locking tooth 29 and therefore comes out of locking engagement with the locking tooth 29. In this pivoting position, the holder 10 can be pulled off the threaded bolt 27 and therefore off the bearing plate 26, if necessary following the removal of the wing nut 31 or a comparable securing means. The bearing plate 26 is, for example, fitted to the front side of a housing of the filling device.

Thus, the hose lines 5, 5′, which are pulled off their connecting pieces 8 and 8′, can be removed from the hose pumps 7, 7′ and can be removed from the filling device in a simple manner with the holder 10 together with the capillaries 6 and 6′. Therefore, these parts contacting the liquid medium 2, 2′ can be sterilized in an autoclave.

The detector device 12 contains a light source 13, for example a semiconductor diode laser with a wavelength of 670 nm and an output power of less than 1 mW, which transmits a measuring beam through the capillary 6 at a measuring point 14 (the second capillary 6′ is located outside the measuring beam). A receiver 15 belonging to the detector device 12 contains a silicon photodiode. The detector device 12 counts the capsules 3 and determines the capsule size by means of an optical extinction measurement at the measuring point 14. The capsules 3 are separated in the tapering capillary 6 as they flow through and, if they deviate from the spherical shape, are aligned in the flow direction. The extinction is measured as shadowing of the laser measuring beam as it passes through a capsule 3. The receiver 15 converts the intensity of light of the received laser measuring beam into an electrical signal, which is processed further electronically and digitized for the evaluation. The attenuation of the intensity of light of the laser measuring beam as it passes through a capsule 3 is correlated directly with the size of the capsule 3. The capsule size is determined from the reduction in the intensity of the light and the counting is triggered.

A transport device 16 in each case positions a collecting container 17 or a collecting vessel in a filling position underneath the two capillaries 6 and 6′. The collecting containers 17 are, for example, ampoules with a filling volume of, for example, 15 ml.

A control device 18 is connected to the detector device 12, to the two hose or peristaltic pumps 7 and 7′ and to the transport device 16.

In order to fill capsules 3, first of all a collecting container 17 is moved into the filling position under the two capillaries 6 and 6′. By means of a control signal, for example via a pressure switch arranged on the filling device, the first hose or peristaltic pump 7 is set operating, so that the conveying device 1 conveys the medium 2 with the capsules 3 contained therein out of the storage container 4 to the capillary 6 and into the collecting container 17, the actual volume (medium 2 with capsules 3) conveyed by the hose or peristaltic pump 7 being registered on the basis of the known volume flow during the pump rotation and the capsules 3 passing the measuring point 14 being counted and their size being determined by means of the detector device 12 in the capillary 6.

When a set number of capsules 3 has been reached and thus put into the collecting container 17, the conveyance is stopped by the control device 18 by stopping the hose or peristaltic pump 7. The actual filled volume is compared with the set desired volume of the collecting container 17 to be filled. If the actual volume is less than the desired volume, the control device 18 actuates the second conveying device 1′, which conveys the medium 2′ from the storage container 4′ in a known volume flow via the second capillary 6′ into the collecting container 17 until the desired filled volume has been reached. The control device 18 then stops the second conveying device 1′ and actuates the transport device 16, which removes the filled collecting container 17 from the filling position and brings the next collecting container 17 to be filled into the filling position. The transport device 16 contains a conveying section which, for example, has a conveyor belt 19 which can be moved by a drive motor 20 actuated by means of the control device 18.

For the respectively current or the entire previous filling, the relevant data is displayed on a display on the filling device, such as the current number of the filling, the set number of capsules to be put in the and set desired volume, the number of filled capsules and the actual volume put in, the average capsule size, the minimum and the maximum capsule size and the standard deviation.

If the desired volume in the collecting container 17 is reached during the filling of the capsules 3 before the set number of capsules 3 has passed into the collecting container 17 with the liquid medium 2, this filling operation is ended, and a signal is generated which points to the too low number of capsules 3 in this collecting container.

The hose or peristaltic pump 7, 7′, according to the illustration, contains a rotary lever having two rollers which are in engagement with the hose. For the purpose of more precise metering of the volume flow, the hose or peristaltic pump 7, 7′ can have a larger number of rollers in a circular arrangement which, for example, are mounted on a pump wheel, so that a smaller volume is conveyed between two rollers. If use is made of two pump wheels arranged beside each other which have rollers offset in relation to one another, a virtually pulse-free volume flow is conveyed via two parallel hose lines.

The holder 10 can also be fitted to the bearing plate 26 or the housing of the filling device in such a way that the threaded bolt 27 or the pivot axis is located at the top in an arrangement inverted with respect to the illustration, and the spring hook 24 is fitted at the lower end. The bores 21 and 22 are positioned in the holder 10 in accordance with the arrangement of the light source 13 and of the receiver 15.

### LIST OF DESIGNATIONS

1 First conveying device
1′ Second conveying device
2 Liquid medium
2′ Liquid medium
3 Capsule
4 Storage container
4′ Storage container
5 Hose line
5′ Hose line
6 Capillary
6′ Capillary
7 Hose pump
7′ Hose pump
8 Connecting piece
8′ Connecting piece
9 Discharge line
9′ Discharge line
10 Holder
11 Hose guide
11′ Hose guide
12 Detector device
13 Light source
14 Measuring point
15 Receiver
16 Transport device
17 Collecting container
18 Control device
19 Conveyor belt
20 Drive motor
21 Bore
22 Bore
23 Hole
24 Spring hook
25 Rear
26 Bearing plate
27 Threaded bolt
28 Inclined face
29 Locking tooth
30 Helical spring
31 Wing nut
32 Shoulder

1. A filling device for capsules, in particular medicament capsules, containing
a first conveying device (1), which feeds a first liquid medium (2) containing the capsules (3) with a defined volume flow to a collecting vessel (17) via a first feed line (5, 6),
a detector device (12), which detects and counts the capsules (3) passing a measuring point (14) in the first feed line (5, 6),
a control device, which stops the first conveying device (1) when a predetermined number of capsules (3) is reached and compares the actual volume fed to the collecting vessel (17) with a desired volume to be put in and forms a volume difference value, and a second conveying device (1′), which feeds second liquid medium (2′) to the collecting vessel (17) via a second feed line (5′, 6′) as a function of the determined volume difference value until the desired volume is reached.

2. The filling device as claimed in claim 1, characterized in that the second conveying device (1′) feeds second liquid medium (2′) to the collecting vessel (17) in a volume corresponding to the volume difference value if the volume difference value exceeds a specific value.

3. The filling device as claimed in claim 1 or characterized in that the first feed line has a transparent capillary (6) at the outlet to the collecting vessel (17), and in that the detector device (12) transmits a light measuring beam for detecting the capsules (3) through the capillary (6).

4. The filling device as claimed in claim 1, characterized in that the second conveying device (1′) has a capillary (6′).

5. The filling device as claimed in claim 3, characterized in that the two capillaries (6, 6′) are held by means of a common holder (10).

6. The filling device as claimed in claim 1, characterized in that the first conveying device (1) and the second conveying device (1′) each have a hose or peristaltic pump (7 and 7′, respectively).

7. The filling device as claimed in claim 5 claim 5, characterized in that the two capillaries (6, 6′) are connected by means of flexible hoses (5 or 5′) to the respective hose or peristaltic pump (7 or 7′) and, together with the holder (10) detachably fixed to the filling device and the hoses (5, 5′), can be removed from the filling device.

8. The filling device as claimed in claim 7, characterized in that the holder (10) is mounted on a pivot axis (27) and can be fixed in a latching position by means of a locking device (24, 29) and, by being pivoted about the pivot axis (27), can be released from the latching position and removed from the pivot axis (27).

9. The filling device as claimed in claim 1, characterized in that the control device controls a transport device (16) for collecting vessels (17) in such a way that the collecting vessels (17) are respectively moved into a filling position under the feed lines or the capillaries (6, 6′) and, after being filled, are removed from the filling position.

10. The filling device as claimed in claim 1, characterized in that it has a first storage container (4) or a first connection (8) for a first storage container (4) for the first liquid medium (2) containing the capsules (3), and in that it has a second storage container (4′) or a second connection (8′) for a second storage container (4′) for the second liquid medium (2′).

11. The filling device as claimed in claim 3, characterized in that the transparent capillary (6) of the first conveying device (1) has a minimum diameter at the measuring point (14) in the range from about 1.0 to 1.6 mm.

12. A method for filling capsules, in particular medicament capsules, into a collecting vessel,
a first liquid medium (2) containing the capsules (3) being fed with a defined volume flow to a collecting vessel (17) via a first feed line (5,6) by means of a first conveying device (1), the capsules (3) passing a measuring point (14) in the first feed line (5) being detected and counted,
the feed of the first liquid medium (2) containing the capsules (3) being stopped when a predetermined number of capsules (3) is reached, the actual volume fed to the collecting vessel (17) being compared with a desired volume to be put in and a volume difference value being formed and,
if required, second liquid medium (2′) being fed to the collecting vessel (17) via a second feed line (5′,6′) by means of a second conveying device. (1′) as a function of this volume difference value until the desired volume is reached.

13. The method as claimed in claim 12, characterized in that, if the desired volume is reached during the feed of the first liquid medium containing the capsules before the predetermined number of capsules has been counted, a signal is generated.

14. The method as claimed in claim 12, characterized in that the size of the capsules passing the measuring point is determined.
